(19) United States
(12) Patent Application Publication
(10) Pub. No.: US 2015/0370980 A1
(43) Pub. Date: Dec. 24, 2015

(54) INTERACTIVE AND INTELLIGENT PERSONAL HEALTHCARE ADVISORY SYSTEM

(71) Applicant: National Taiwan University, Taipei City (TW)

(72) Inventor: Yea-Li Sun, Taipei City (TW)

(21) Appl. No.: 14/470,701

(22) Filed: Aug. 27, 2014

Related U.S. Application Data
(63) Continuation of application No. 29/494,477, filed on Jun. 20, 2014.

(51) Int. Cl. G06F 19/00; H04L 29/08; G06N 5/04

(52) U.S. Cl. CPC G06F 19/345; G06N 5/04; H04L 67/10

(57) ABSTRACT

The present invention provides a method and a system for providing personal healthcare advisory. The user interface visualizes and guides the users to describe their health conditions via graphical display and/or selectable lists. The intelligence inference engine incorporates various databases, knowledge bases and creates an interactive and eliciting scenario. The method and system for providing personal healthcare advisory of the present invention can not only stimulate a virtual experience for the user to participate but also provide user with rapid, accurate, and personalized healthcare advisory; hence, promotes the users' willingness to acquire preventive healthcare information and builds a healthier society.

### CROSS-REFERENCES TO RELATED APPLICATIONS

This application claims priority to U.S. Design Pat. Application No. 29/494,477 filed on 20 Jun. 2014. All disclosure of which is incorporated herein by reference in its entirety.

### BACKGROUND OF THE INVENTION

1. Field of the Invention

The present invention is related to a healthcare advisory system; more specifically, the present invention is related to an interactive and intelligent personal healthcare advisory system with 3-dimentional body map.

2. The Prior Arts

In recent years, for the purpose of providing patients with better services, healthcare facilities, such as hospitals, have been establishing and recruiting Case Managers to consult and monitor individual needs for each patient. Due to the rise of cost in National Health Insurance and the influence of aging society, the government not only promotes training courses and certification for Nurse Practitioners but also inputs enormous resources into the field of preventive healthcare. However, since preventive healthcare is profession-oriented, ordinary citizens can only seek advice through specified healthcare facilities such as hospitals or medical centers. This inconvenience significantly reduces the citizens' willingness to acquire information regarding preventive healthcare and, consequently, increases the risk of critical illnesses and the burden on healthcare resources.

With the popularity of mobile devices, such as smart phones and tablets, and internet accessibility, such as wifi and 3G, people nowadays rely on the internet for solving problems in nearly all aspect of their lives. Search engines, for instance, allows people to search and obtain information rapidly. However, in terms of preventive healthcare, the information provided by the search engines often fail to meet the actual needs of ordinary users since the users do not have the professional background knowledge to filter exceeding amount of search results. Besides, ordinary users are not likely to be able to fully describe their conditions in words.

While some healthcare advisory systems are available on the internet, most systems inquire users' health related data in a unilateral questioning manner. Due to lacking interactive and eliciting scenarios, this type of systems cannot provide its users with rapid, accurate, and appropriate healthcare advisories.

In order to promote preventive healthcare to the general public and therefore promote the health level of the society, it is of great necessity for an interactive system or method that provides rapid, accurate, and personalized healthcare advisories.

### SUMMARY OF THE INVENTION

As a result, the present invention provides a method for providing healthcare advisory, comprising: receiving, by using a first interaction element on a user interface, a subjective health condition from a user; inferring, using an intelligence engine, healthcare information from a plurality of bases based on the subjective health condition; and updating, by the intelligence inference engine, a gauge on the user interface, wherein if the gauge reaches a target, the intelligence inference engine produces a least one healthcare advisory via a fourth interaction element on the user interface.

The method of the present invention further comprises interacting, by the intelligence inference engine, with the user, if the gauge does not reach the target, wherein the intelligence inference engine asks at least one objective health question related to the subjective health condition via a second interaction element on the user interface; receiving, by the intelligence inference engine, at least one answer to the objective health question via the user interface, wherein the user interface allows the user to select at least one answer from a plurality of option boxes designated with the description or image of appropriateness via a third interaction element and/or from a plurality of regions of the 3-dimentional body map corresponding to the options in the plurality of option boxes via the first interaction element on the user interface; correlating, by the intelligence inference engine, the subjective health condition and the answer to the objective health question to at least one possible symptom and at least one advisory; and presenting, on the user interface, the fourth interaction element simultaneously showing the possible symptom and the healthcare advisory inferred from the intelligence inference engine.

In one embodiment of the present invention, the first interaction element is a 3-dimentional body map enabling the user to select a plurality of region thereon corresponded to the subjective health condition; the second interaction element is a dialog displaying the objective health question inferred by the intelligence inference engine; the third interaction element further comprises a plurality of relevance indictors showing the level of relevance between the option box and the objective health question; the fourth interaction element is a window displaying the health advisory inferred by the intelligence inference engine. According to the present invention, the plurality of bases comprises healthcare knowledge bases, clinical experience bases, and big data from healthcare authorities.

Another aspect of the present invention is to provide an interactive system for providing personal healthcare advisory, the system comprises: a server comprising:
a user interface comprising a plurality of interaction elements, the user interface is configured to provide to a user device via a network and receive a subjective health condition form a user; and
an intelligence inference engine configured to infer at least one health advisory from a plurality of bases based on the subjective health condition; and
   a manager device configured to program the user interface and the intelligence inference engine of the server via the network.

In one embodiment of the present invention, the interaction element comprises a first interaction element enabling the user to select a plurality of region corresponded to the subjective health condition; a second interaction element displaying the objective health question inferred by the intelligence inference engine; a third interaction element allowing the user to respond to the objective health question by selecting answers from a plurality of option boxes; a fourth interaction element displaying the heath advisory inferred by the intelligence inference engine. According to the present invention, the network is selected from the group consisting of Internet, a private network, and a network of public and private networks accessible to the user device and the manager device. The manager device is a personal computer capable of maintaining and editing information in the plurality of bases of the intelligence inference engine. The plurality of bases comprises healthcare knowledge bases, clinical experience bases, and big data from healthcare authorities. The intelligence inference engine further comprises a logic unit configured to process information from the user and the plurality of bases.

The present invention utilizes Information and Communication Technology (ICT) as well as mobile devices, such as smart phones and tablets, to provide a healthcare advisory system, which provides accurate, appropriate, and personalized healthcare advisory to the users. The intelligence inference engine of the system of the present invention incorporates preventive healthcare knowledge base, clinical experiences from physicians, and big data from healthcare authorities, such as National Health Insurance Administration, Ministry of Health and Welfare, Republic of China, in order to generate rapid, precise, and personalized healthcare advisory.

The present invention is further explained in the following embodiment illustration and examples. Those examples below should not, however, be considered to limit the scope of the invention, and it is contemplated that modifications will readily occur to those skilled in the art, which modifications will be within the spirit of the invention and scope of the appended claims.

### BRIEF DESCRIPTION OF THE DRAWINGS

FIG. 1, a schematic implementation of the interactive and intelligent personal healthcare advisory system of the present invention.

FIGS. 2A-2E, illustration of the user interface with interaction elements, wherein FIG. 2A is a first interaction element represented as 3-dimentional body maps; FIG. 2B is a second interaction element represented as a dialog; FIG. 2C is a third interaction element; FIG. 2D is a fourth interaction element represented as a dialog; FIG. 2E is the overview of the user interface when the interaction is completed.

FIG. 3 is an exemplary demonstration of the user interface with interaction elements being displayed on a user device.

FIG. 4, a block diagram for the system for providing personal healthcare advisory of the present invention.

FIG. 5, flow chart of the method for providing healthcare advisory of the present invention.

### DETAILED DESCRIPTION OF THE PREFERRED EMBODIMENT

Reference will now be made to the accompanying drawings, which at least will assist in illustrating the various pertinent features of the present invention. In this regard, the following description is presented for purposes of illustration and description and is not intended to limit the invention to the form disclosed herein. Consequently, variations and modifications commensurate with the following teachings, and skill and knowledge of the relevant art, are within the scope of the present invention. The embodiments described herein are further intended to enable others skilled in the art to utilize the invention as described or in other embodiments and with various modifications required by the particular applications or uses of the present invention.

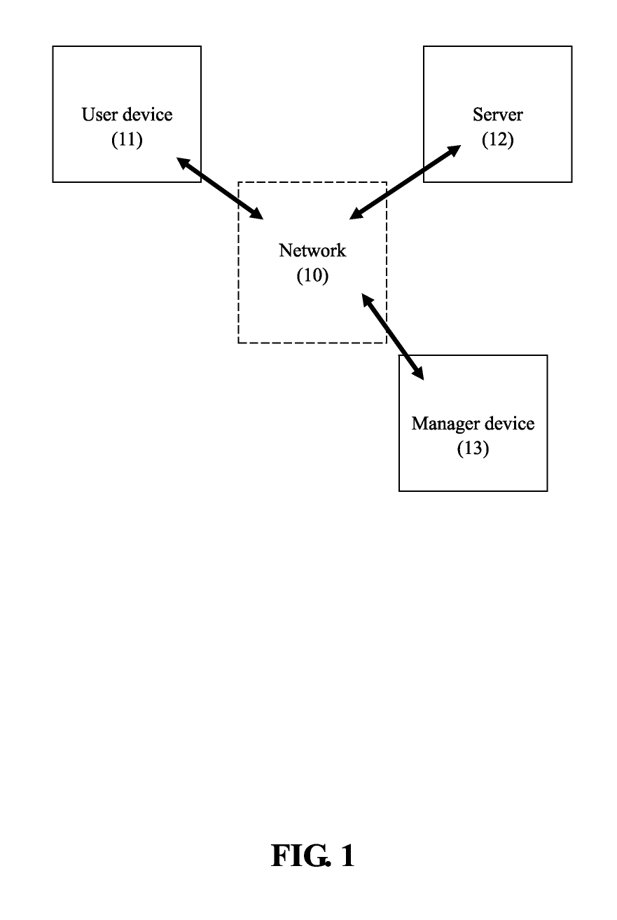

FIG. 1 describes the operation of the system of the present invention in a network environment. Doctors, physicians, or technicians can update information, program codes, or advertisements to a server 12 using a manager device 13 via a network 10. The network 10 can be a private/public cable or wireless (3G, 4G, etc) network. The server 12 is stored in any readable and programmable environment such as a cloud storage space, a host, etc.

A user can download the user interface as an application from online application stores, such as Apple store, Google play, etc, to a user device 11 with touch panel. The user device 11 includes smart phones, tablets, etc.

Some data may already be attached when the application is downloaded, which allows the user to still use the system without connecting to the network 10. The data can be presented in words, images, or statistical charts, etc., and the user is not limited to any group of people in terms of age, occupation, educational background, ethics, etc.

If the user can connect to the network 10, the network 10 can automatically download the most updated and latest data from the server 12 to the user device 11.

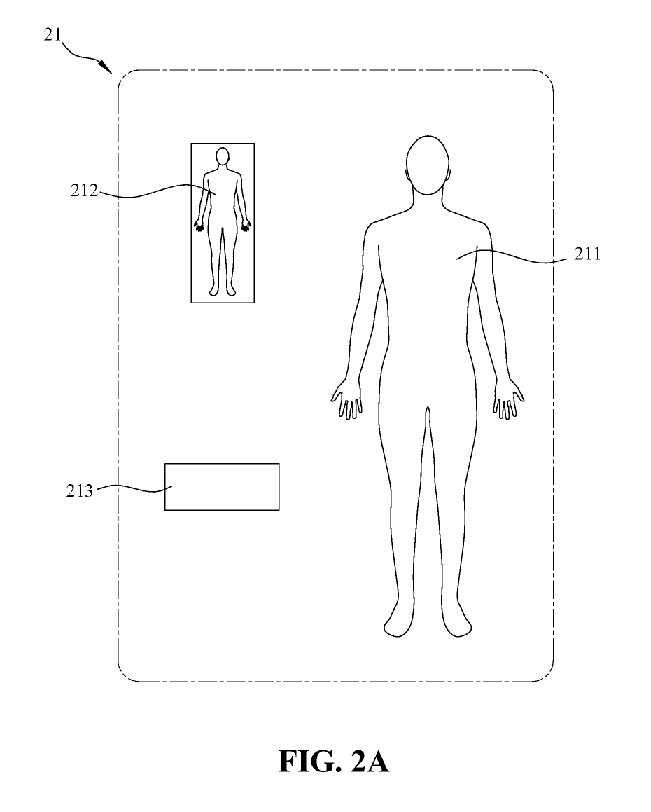

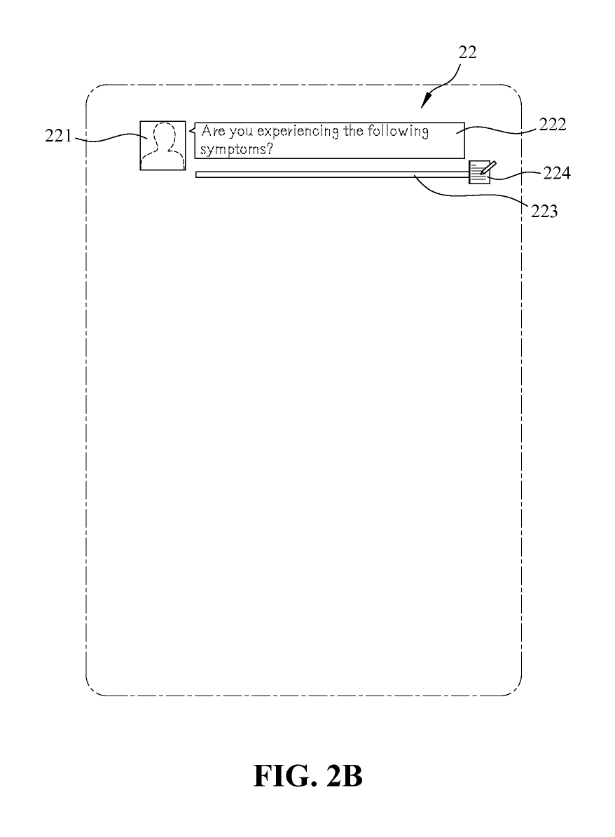

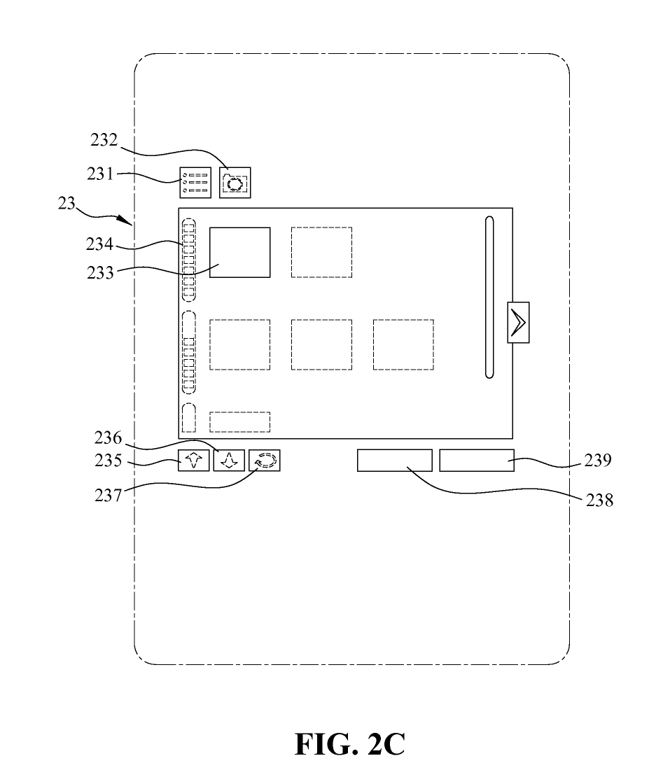

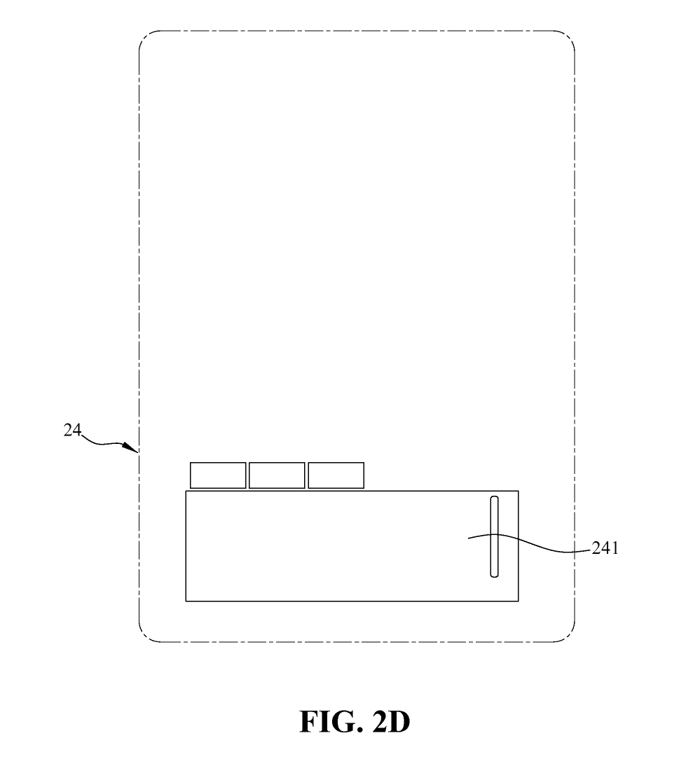

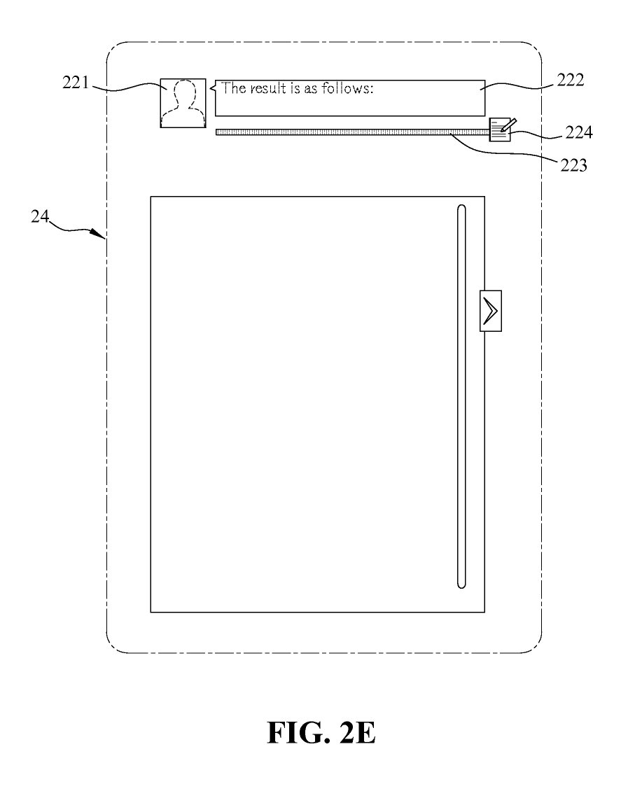

FIG. 2A to FIG. 2E are illustrations of the user interface with interaction elements of the present invention. FIG. 2A is the first interaction element 21. A 3-dimentional body map 211 includes a complete human body illustration with hierarchies. By using appropriate gestures as commands, the 3-dimentional body map 211 is able to magnify, minify, move, or rotate. When the 3-dimentional body map 211 is magnified or minified, body parts of different hierarchies can be seen. Additionally, a miniature 3-dimentinal body map 212 can assist the user to rotate, magnify, or minify the 3-dimentional body map 211, and also enables the user to locate the body region of interest on the 3-dimentional body map 211 with ease. Preferably, a column 213 is included where a list of body parts are categorized and arranged according to their hierarchies. Alternatively, the user can select from the column 213, and upon the selection, the corresponding region on the 3-dimentional body map 211 will be highlighted by, for instance, changing in color.

FIG. 2B is the second interaction element 22 presented as a dialog. The second interaction element 22 includes a portrait 221, a question dialog 222, a gauge 223, and a target 224. Questions will be shown in the question dialog 222. Upon the gauge 223 reaching the target 224, the interaction is completed.

FIG. 2C is the third interaction element 23. The third interaction element 23 includes a menu icon 231, a camera icon 232, a plurality of option boxes 233, a plurality of relevance indicators 234, a “back to the previous question” button 235, a “back to the next question” button 236, a “refresh” button 237, a “confirm” button 238, and a “none of above” button 239. Upon selecting the camera icon 232, the system will link a camera on a mobile device of the user to the user interface, and by clicking the “confirm” button 238, the system will upload an image taken by the camera on the mobile device of the user to the intelligence inference engine for analysis. According to different scenarios, the plurality of option boxes 233 will display multiple options; those options may simultaneously contain image and written descriptions. The options will be listed in the plurality of option boxes 233 according to their relevance which allows the user to make single or multiple choices reflecting the health condition of the user. The plurality of relevance indicators 234 also provides the user with hints and eliciting scenarios to assist the user when making the choice(s) of appropriateness. For editing the choices made, the user can also utilize the “back to the previous question” button 235, the “back to the next question” button 236, and “refresh” button 237 to make corrections when desired.

Some options may require simultaneously selecting the option in the plurality of option boxes 233 and the 3-dimentional body map 211 as shown in FIG. 2A. The intelligence inference engine will analyze upon the “confirm” button 238 is clicked. Alternatively, if none of the options correspond to the user's health condition, the intelligence inference engine can still precede the analysis when the “none of above” button 239 is clicked. When the gauge 223 reaches the target 224, the interaction is completed and the third interaction element 23 will disappear.

FIG. 2D is the fourth interaction element 24. The fourth interaction element 24 presents the summary including healthcare advisory and any other additional information. Each interaction along with the questions asked by the intelligence inference engine will be summarized in a result window 241.

FIG. 2E is the illustration of the user interface when the user completes the interaction. When the gauge 223 reaches the target 224, the interaction is completed and the fourth interaction element 24 expands and replaces the disappeared third interaction element 23.

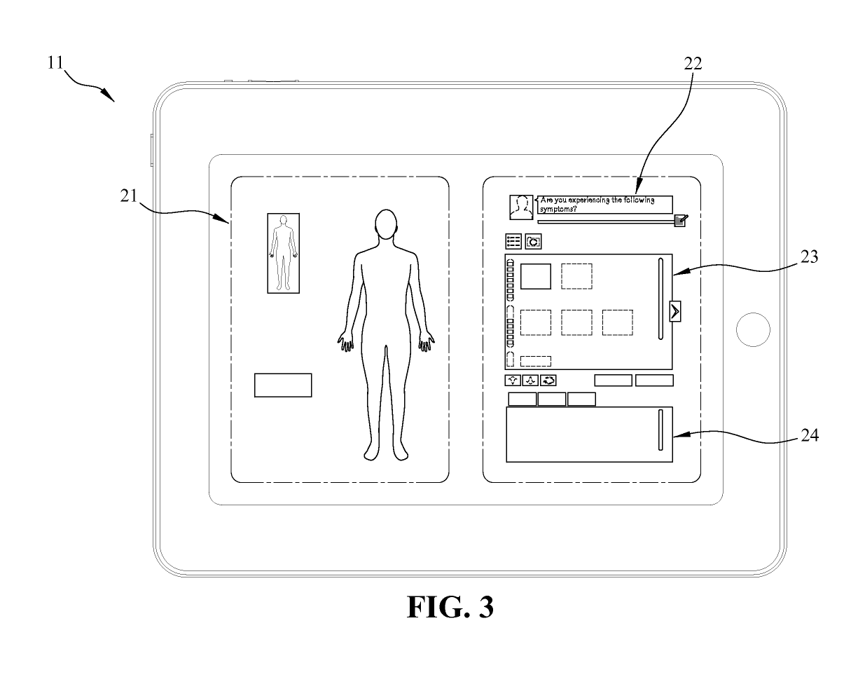

FIG. 3 is the exemplary demonstration of the user interface with interaction elements being displayed on a user device 11. The user device 11 is, preferably, a tablet. The first interaction element 21 is displayed on the left-hand proportion of the screen of the tablet, while the second, third, and fourth interaction elements 22, 23, 24 are displayed on the right-hand proportion of the screen of the tablet. Since both the first interaction element 21 and the third interaction element 23 are displayed on the screen of the tablet, the user is able to simultaneously select the option in the plurality of option boxes of the third interaction element 23 and the 3-dimentional body map of the first interaction element 21 in response to the subjective health question in the second element 22. Relative position and size of the interaction elements are not limited and can be readily adjusted according to the user's preferences.

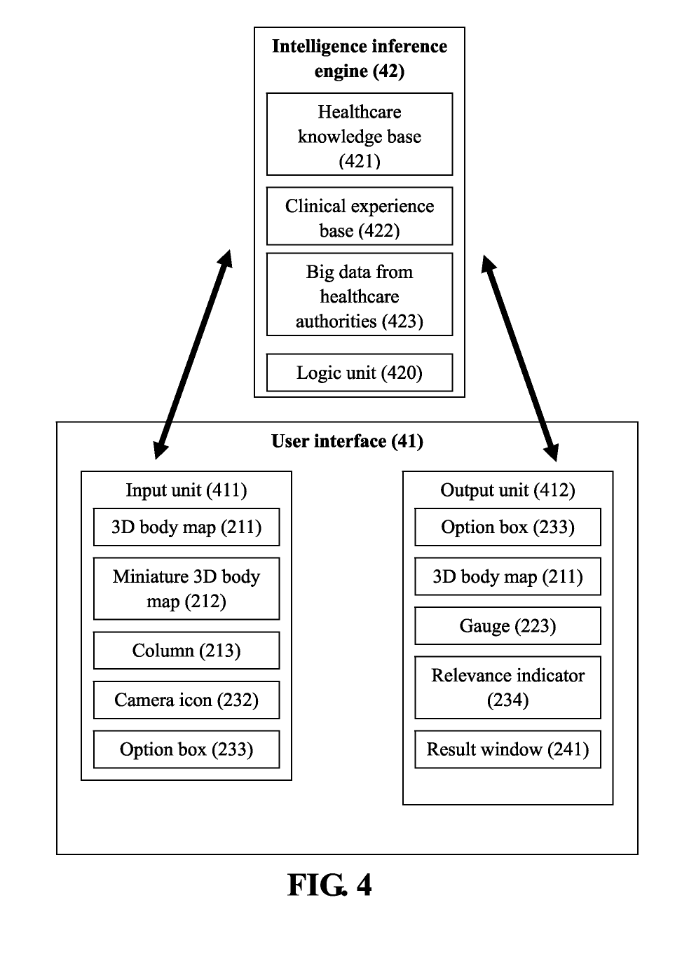

FIG. 4 illustrates the interaction between the user interface and the intelligence inference engine of the present invention. After selecting options from the option box 233 and/or 3-dimentional body map 211, from the column 213, or from images uploaded via the camera icon 232 and an external camera device, the user interface 41 sends the information inputted to the intelligence inference engine 42 of the system, which correlates the information inputted with a healthcare knowledge base 421, a clinical experience base 422, and a big data from healthcare authority 423 to infer at least one possible option using a logic unit 420. An output unit 412 then determines, according to the relevance of the options, whether to list the options in the option box 233, or to display the options on the 3-dimentional body map 211, or both. After each inference by the intelligence inference engine 42, the gauge 223 is updated, allowing the user to keep on track of the progress.

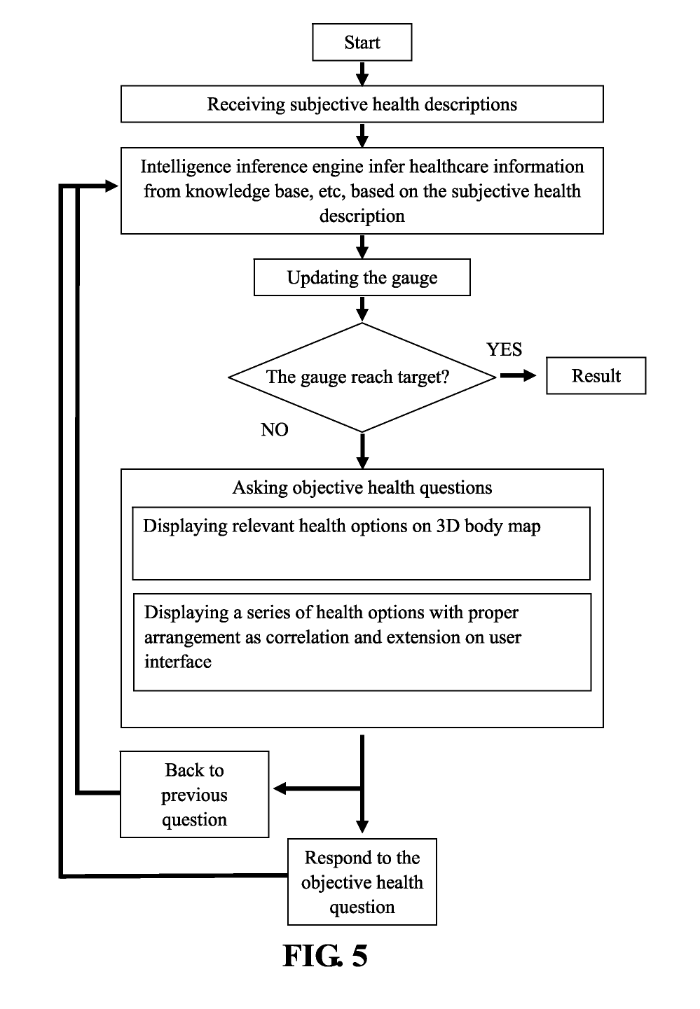

FIG. 5 describes a flow chart of the method for providing healthcare advisory of the present invention. When the user select the desired body region from the 3-dimentional body map 211 or the column 213, the system makes inference base on the selection and the data in the healthcare knowledge base, etc. Meanwhile, the gauge 223 will change according to the inference made. If the gauge 223 failed to reach the target 224, which indicates the system cannot infer at least one possible symptom corresponded to the subjective health condition of the user; the system will produce at least one objective health question and display it in the option box 233 for the user to answer. The objective health question may also be displayed on the 3-dimentional body map 211. After answering the objective health question by selecting at least one option and the “confirm” button 238, or the “none of above” button 239, the system proceeds to inference. In addition, the user can also edit the choice made using the “back to the previous question” button 235, the “back to the next question” button 236, and the “refresh” button 237. When another option is selected, the gauge 223 will recalculate the progress.

When the system matches at least one symptom similar or identical to the user's health condition, the gauge 223 will reach the target 224, and the third interaction element 23 will be replaced by the fourth interaction element 24, in which the inferred healthcare information, data, articles, hyperlinks, advertisements, or products related to the user's health condition is recommended to the user.

The method and system for providing personal healthcare advisory of the present invention is applicable and valuable to the industry. Those embodiments above are better operations, and should not, however, be considered to limit the scope of the invention, it is contemplated that modifications will readily occur to those skilled in the art, which modifications will be within the spirit of the invention and scope of the appended claims.

What is claimed is:

1. A method for providing healthcare advisory, comprising:
receiving, by using a first interaction element on a user interface, a subjective health condition from a user;
inferring, using an intelligence inference engine, healthcare information from a plurality of bases based on the subjective health condition; and
updating, by the intelligence inference engine, a gauge on the user interface, wherein if the gauge reaches a target, the intelligence inference engine produces at least one healthcare advisory via a fourth interaction element on the user interface.

2. The method of claim 1, further comprises:
interacting, by the intelligence inference engine, with the user, if the gauge does not reach the target, wherein the intelligence inference engine asks at least one objective health question related to the subjective health condition via a second interaction element on the user interface;
receiving, by the intelligence inference engine, at least one answer to the objective health question via the user interface, wherein the user interface allows the user to select at least one answer from a plurality of option boxes designated with the description or image of appropriateness via a third interaction element and/or from a plurality of regions of the 3-dimentional body map corresponding to the options in the plurality of option boxes via the first interaction element on the user interface;
correlating, by the intelligence inference engine, the subjective health condition and the answer to the objective health question to at least one possible symptom and at least one advisory; and
presenting, on the user interface, the fourth interaction element simultaneously showing the possible symptom and the healthcare advisory inferred from the intelligence inference engine.

3. The method of claim 1, wherein first interaction element is a 3-dimentional body map enabling the user to select a plurality of region thereon corresponded to the subjective health condition.

4. The method of claim 2, wherein the second interaction element is a dialog displaying the objective health question inferred by the intelligence inference engine.

5. The method of claim 2, wherein the third interaction element further comprises a plurality of relevance indicators showing the level of relevance between the option box and the objective health question.

6. The method of claim 1, wherein the fourth interaction element is a window displaying the health advisory inferred by the intelligence inference engine.

7. The method of claim 1, wherein the plurality of bases comprises healthcare knowledge bases, clinical experience bases, and big data from healthcare authorities.

8. An interactive system for providing personal healthcare advisory, the system comprises:
a server comprising:
a user interface comprising a plurality of interaction elements, the user interface is configured to provide to a user device via a network and receive a subjective health condition from a user; and
an intelligence inference engine configured to infer at least one health advisory from a plurality of bases based on the subjective health condition; and
a manager device configured to program the user interface and the intelligence inference engine of the server via the network.

9. The system of claim 8, wherein the interaction element comprises a first interaction element enabling the user to select a plurality of region corresponded to the subjective health condition.

10. The system of claim 8, wherein the interaction element comprises a second interaction element displaying the objective health question inferred by the intelligence inference engine.

11. The system of claim 8, wherein the interaction element comprises a third interaction element allowing the user to respond to the objective health question by selecting answers from a plurality of option boxes.

12. The system of claim 8, wherein the interaction element comprises a fourth interaction element displaying the health advisory inferred by the intelligence inference engine.

13. The system of claim 8, wherein the network is selected from the group consisting of the Internet, a private network and a network of public and private networks accessible to a user device and the manager device.

14. The system of claim 8, wherein the manager device is a personal computer capable of maintaining and editing information in the plurality of bases of the intelligence inference engine.

15. The system of claim 8, wherein the plurality of bases comprises healthcare knowledge bases, clinical experience bases, and big data from healthcare authorities.

16. The system of claim 8, wherein the intelligence inference engine further comprises a logic unit configured to process information from the user and the plurality of bases.
